(19) United States
(12) Patent Application Publication
(10) Pub. No.: US 2002/0103102 A1
(43) Pub. Date: Aug. 1, 2002

(54) Branched reaction products of amines and multifunctional compounds

(76) Inventors: Stephen F. Gross, Souderton, PA (US); Wei Li, Mason, OH (US); Jianhua Mao, West Chester, OH (US); Norman Tuller, Simpsonville, SC (US); Michael S. Wiggins, Lansdale, PA (US)

Correspondence Address: COGNIS CORPORATION, 2500 RENAISSANCE BLVD., SUITE 200, GULPH MILLS, PA, 19406

(21) Appl. No.: 09/975,357

(22) Filed: Oct. 11, 2001

Related U.S. Application Data
(60) Provisional application No. 60/256,375, filed on Dec. 18, 2000.
(60) Provisional application No. 60/281,472, filed on Apr. 4, 2001.

(51) Int. Cl. C11D 1/00

(52) U.S. Cl. 510/499

(57) ABSTRACT

Reaction products of A) an amine of formula I

RX(EO)ₙ(PO)ₘ(BO)ₚZNHR₁ (I)

wherein R is a substituted or unsubstituted, saturated or unsaturated, organic group having from 4 to 36 carbon atoms, R₁ is hydrogen or a C₁-C₂₀ straight or branched chain alkyl group, optionally substituted with a hydroxyl group, X is —O—, —S—, or —NR₃— where R₃ is hydrogen or a C₁-C₄ alkyl group, Z is ethylene, propylene or butylene, n is a number of from 0 to 100, m is a number of from 0 to 50: and p is a number of from 0 to 50, provided that the sum of n, m and p is at least one; and B) a multifunctional compound of formula II

R₂(Y)ₘ (II)

where R₂ is a straight or branched chain alkyl, alkenyl, or cycloaliphatic group having from 2 to 30 carbon atoms, or an unsubstituted or alkyl substituted aromatic group, the Y groups are carboxyl, carboxylic anhydride, halogen, carbonyl, acetyl halide, keto, aldehyde, or epoxy, and m is a number of from 2 to 10, and wherein the Y groups can be the same or different; and liquid compositions containing them.

### CROSS REFERENCE TO RELATED APPLICATIONS

This application claims the benefit of copending provisional application serial No. 60/256,375, filed on Dec. 18, 2000, and provisional application serial No. 60/281,472 filed on Apr. 4, 2001; the entire contents of each of which are incorporated herein by reference.

### FIELD OF THE INVENTION

This invention relates to reaction products useful as low foaming surfactants and as defoaming agents in aqueous and nonaqueous liquid compositions.

### BACKGROUND OF THE INVENTION

Aqueous cleaning compositions exhibit a tendency toward foaming since they contain surface active agents such as soaps, and synthetic detergents. In many instances, such cleaning compositions produce excessive foam and the user must add substances known as anti-foaming agents or defoamers. Some defoamers such as silicones tend to interfere with the function of the cleaning compositions in that unwanted residues are left after the cleaners are wiped off, while others are environmentally unacceptable because they are not biodegradable.

Alkyl polyglycosides are a class of nonionic surfactants that exhibit significantly higher foaming profiles than other nonionic surfactants, such as alcohol ethoxylates. In fact, the foaming tendencies of alkyl polyglycosides more closely resemble those of anionic surfactants, such as alcohol sulfates, than the foaming tendencies of other nonionic surfactants. This higher foaming tendency makes the use of alkyl polyglycosides alone undesirable for many applications, e.g. cleaning-in-place for food processing plants, high pressure spray cleaning, bottle washing, floor cleaners and automatic dishwashing, wherein high levels of foam interfere with the cleaning and rinsing operation and reduce the efficiency of the operation.

Low foam nonionics, such as EO/PO block copolymers, can be used to reduce the foaming properties of alkyl polyglycoside and anionic surfactants, but these materials have undesirable properties, e.g. low biodegradability, relatively high aquatic toxicity and poor caustic compatibility.

Accordingly, there is a need for the development of defoamers that do not interfere with the cleaning ability of aqueous cleaning compositions and that are biodegradable, exhibit low aquatic toxicity, and good caustic compatibility.

There is also a need for defoamers for nonaqueous compositions.

In addition, there is a continuing need for low foaming surfactants for use in both aqueous and nonaqueous compositions.

### SUMMARY OF THE INVENTION

This invention relates to reaction products of

A) an amine of formula I

RX(EO)ₙ(PO)ₘ(BO)ₚZNHR₁ (I)

wherein R is a substituted or unsubstituted, saturated or unsaturated, organic group having from 4 to 36 carbon atoms, R₁ is hydrogen or a C₁-C₂₀, preferably a C₁-C₁₂, straight or branched chain alkyl group, optionally substituted with a hydroxyl group, X is —O—, —S—, or —NR₃— where R₃ is hydrogen or a C₁-C₄ alkyl group, Z is ethylene, propylene or butylene, n is a number of from 0 to 100, e.g., from 1 to 100, m is a number of from 0 to 50 e.g., from 1 to 50; and p is a number of from 0 to 50 e.g., from 1 to 50, provided that the sum on n, m and p is at least one; and

B) a multifunctional compound of formula II

R₂(Y)ₘ (II)

where R₂ is a straight or branched chain alkyl, alkenyl, or cycloaliphatic group having from 2 to 30 carbon atoms, or an alkyl substituted or unsubstituted aromatic group, e.g. phenyl; the Y groups are carboxyl, carboxylic anhydride, halogen, e.g. chloro or bromo, carbonyl, acetyl halide, e.g. acetyl chloride, keto (oxo), aldehyde, or epoxy, and m is a number of from 2 to 10. The Y groups can be the same or different.

### DETAILED DESCRIPTION OF THE INVENTION

Other than in the operating examples, or where otherwise indicated, all numbers expressing quantities of ingredients or reaction conditions used herein are to be understood as modified in all instances by the term “about”.

In the compounds of formula I, it is understood that EO stands for the residue of ethylene oxide and PO stands for the residue of propylene oxide and BO stands for the residue of butylene oxide.

The subtituents that optionally can be present on the substituted R groups can be single or multiple substitutions such as one or more halogen substitutions, for example Cl, Fl, I and Br: a sulfur functionality such as a mercaptan or thio group; a nitrogen functionality such as an amine or amide functionality; an alcohol functionality, a silicon functionality, e.g., a siloxane; an ether functionality; or any combination thereof.

In general, compounds of formula I wherein the sum of n, m, and p is at least 2, are preferred.

The R group can be any substituted or unsubstituted, saturated or unsaturated organic moiety having from 4 to 36 carbon atoms. Thus, the R groups can be linear or branched alkyl groups, linear or branched alkenyl or alkynyl groups, saturated carbocyclic moieties, unsaturated carbocyclic moieties having one or more multiple bonds, saturated heterocyclic moieties, unsaturated heterocyclic moieties having one or more multiple bonds, substituted linear or branched alkyl groups, substituted linear or branched alkenyl or alkynyl groups, substituted saturated carbocyclic moieties, substituted unsaturated carbocyclic moieties having one or more multiple bonds, substituted saturated heterocyclic moieties, and substituted unsaturated heterocyclic moieties having one or more multiple bonds. Examples of the above include but are not limited to an alkyl group having from 4 to 22 carbon atoms, an alkenyl group having from 4 to 22 carbon atoms, an alkynyl group having from 4 to 22 carbon atoms. R can also be an aryl or arenyl group. Arenyl groups are alkyl-substituted aromatic radicals having a free valence at an alkyl carbon atom such as a benzylic group. Aryl groups include phenyl or C₁-C₁₂ substituted phenyl, or an alkyl substituted or unsubstituted polycyclic aromatic group, e.g., naphthyl. Alkyl groups having from 4 to 12 carbon atoms are preferred, and alkyl groups having from 8 to 10 carbon atoms are most preferred. The degree of ethoxylation is preferably from 2 to about 50 with the most preferred being from about 4 to about 50 while the degree of propoxylation and butoxylation can vary from 0 to about 50, preferably from 1 to about 10. The degree of propoxylation and or butoxylation will be determined by the desired degree of solubility or miscibility in aqueous and/or nonaqueous. The solubility or miscibility will ultimately be determined by such factors as the number of carbon atoms in R and the relative amounts of EO, PO and/or BO.

In the above compounds of formula I, the EO, PO and BO groups when present can be in blocks or in random distribution and can be present in any order with respect to the R group, although the alkoxide groups when present are preferably present in the order shown in formula I.

In the reactant B) compounds of formula II, when R₂ is an alkyl or alkenyl group, the group preferably contains from 2 to 12 carbon atoms in the chain. When R₂ is an alkenyl group, one or more double bonds can be present. When R₂ is an aromatic group, the group is preferably phenyl or C₁-C₁₂ alkyl substituted phenyl. However, alkyl substituted or unsubstituted polycyclic aromatic groups can also be used as the aromatic group, such as a naphthyl group and the like.

The reaction between reactants A) and B) can be carried out by reacting the components at a temperature in the range of from 40 to 150° C., preferably from 75 to 110° C., in the presence of a basic catalyst, such as an alkali or alkaline earth metal hydroxide. Sodium hydroxide and potassium hydroxide are preferred. The reaction temperature will depend somewhat on the particular component B) reactant selected for the reaction, and can be readily determined by those skilled in the art. Preferably, the mol ratio of the reactants is based on the number of reactive groups in component B), e.g. if 4 reactive groups are present, the mol ratio of A):B) is at least 4:1.

The component A) reactant can be prepared by known methods. For example, the —OH group in a compound of formula III

RX(EO)ₙ(OP)ₘ(BO)ₚZOH (III)

in which R, X, Z, n, m and p have the meanings given for formula I can be converted to chlorine or bromine and then reacted with ammonia or a C₁-C₂₀ primary amine. When ammonia is the reactant, the product can be further reacted, e.g. with an epoxy C₂-C₂₀ alkane or a C₁-C₂₀ alkyl halide.

The reaction products of the invention can be used as low foaming surfactants in both aqueous and nonaqueous compositions in surfactant-effective amounts, usually from 0.1 to 10% by weight, preferably from 1 to 5% by weight, based on the weight of the composition.

These reaction products can also be used in the above quantities as defoaming agents for aqueous and nonaqueous compositions, and are particularly useful in minimizing or eliminating foaming in aqueous compositions containing high foaming surfactants, such as alkyl polyglycosides and anionic surfactants such as alcohol sulfates.

These reaction products can be used in aqueous cleaning compositions, in emulsion polymer latex compositions such as latex paints, in inks, in adhesives, in metal working compositions, and in other aqueous and nonaqueous compositions in which surfactants and/or defoaming agents are advantageously present.

The reaction products of the invention are biodegradable, contain no organic solvents, and do not adversely affect the detergency of other surfactants that may be present in compositions in which they are used since they are themselves surfactants.

The invention will be illustrated but not limited by the following examples.

### EXAMPLES

### Example 1

96.3 g of Poly (12) oxyethylene (POE (5) decyl) oxypropyl amine and 0.505 g KOH are placed in a 250 ml three neck flask, which is equipped with an addition funnel, a mechanical stirrer and a thermometer. The mixture is purged with nitrogen for 15 minutes, and heated to 140-145° C. 32.8 g of epoxydecane is added over 30 minutes at the above temperature. After the addition, the reaction is held at 145° C. for one hour. The reaction mixture is cooled to 45° C. and neutralized with 0.540 g acetic acid. The final product has a hydroxyl value of 88.

The above product is then reacted with ethylenediamineteraacetic dianhydride at mole ratio 4.1:1.0 at 90° C. for 8 hr.

### Example 2

10 g. of dodecyl alcohol·25 EO and 0.5 g of PCl₃ are reacted for one hour at a temperature of 30° C. in a 250 ml three neck flask. Then 50 g of propylamine is added and reacted at 60° C. for 30 minutes.

The above product is isolated from the reaction mixture by washing with water and drying the residue for 30 minutes at 120° C.

The isolated product is then reacted with 1,1,2-trichloroethane at a temperature of 100° C. for 6 hours at a mol ratio of 3.1:1.

What is claimed is:

1. The reaction product of
A) an amine of formula I
RX(EO)ₙ(PO)ₘ(BO)ₚZNHR₁ (I)
wherein R is a substituted or unsubstituted, saturated or unsaturated, organic group having from 4 to 36 carbon atoms, R₁ is hydrogen or a C₁-C₂₀ straight or branched chain alkyl group, optionally substituted with a hydroxyl group, X is —O—, —S—, or —NR₃— where R₃ is hydrogen or a C₁-C₄ alkyl group, Z is ethylene, propylene or butylene, n is a number of from 0 to 100, m is a number of from 0 to 50: and p is a number of from 0 to 50, provided that the sum of n, m and p is at least one; and
B) a multifunctional compound of formula I
R₂(Y)ₘ (II)
where R₂ is a straight or branched chain alkyl, alkenyl, or cycloaliphatic group having from 2 to 30 carbon atoms, or an unsubstituted or alkyl substituted aromatic group, the Y groups are carboxyl, carboxylic anhydride, halogen, carbonyl, acetyl halide, keto, aldehyde, or epoxy, and m is a number of from 2 to 10, and wherein the Y groups can be the same or different.

2. The reaction product of claim 1 wherein in component A), R₁ is hydrogen or a C₁-C₁₀ alkyl group optionally substituted with a hydroxyl group.

3. The reaction product of claim 1 wherein in component A), the sum of n, m and p is at least 2.

4. The reaction product of claim 1 wherein in component A), X is —O— and R is an alkyl group containing from 4 to 22 carbon atoms.

5. The reaction product of claim 4 wherein R contains from 4 to 12 carbon atoms.

6. The reaction product of claim 1 wherein n=4 to about 50.

7. The reaction product of claim 1 wherein the EO, PO and BO groups when present can be in blocks or in random distribution and can be in any order with respect to the R group.

8. The reaction product of claim 7 wherein EO, PO and BO when present are in the order shown in Formula I.

9. The reaction product of claim 1 wherein in component B), R₂ is an alkyl or alkenyl group containing from 2 to 12 carbon atoms.

10. The reaction product of claim 1 wherein in component A), X is —O—, R is an alkyl group containing from 4 to 22 carbon atoms, n=4 to about 50, and, EO, PO and BO when present are in the order shown in formula I, and in component B), R₂ is an alkyl or alkenyl group containing from 2 to 12 carbon atoms.

11. The reaction product of claim 10 wherein R₁ is hydrogen or a C₁-C₁₀ alkyl group optionally substituted with a hydroxyl group.

12. In an aqueous composition, the improvement wherein a surfactant- or defoaming-effective quantity of the reaction product of claim 1 is present therein.

13. The composition of claim 12 wherein the surfactant- or defoaming-effective quantity is from about 0.1 to about 10% by weight.
